(19) United States
(12) Patent Application Publication
(10) Pub. No.: US 2007/0087310 A1
(43) Pub. Date: Apr. 19, 2007

(54) Dental matrices and clamps therefor

(76) Inventor: Philip Giusti, Commack, NY (US)

Correspondence Address: Thomas A. O'Rourke;Bodner & O'Rourke, 425 Broadhollow Road, Melville, NY, 11747, US

(21) Appl. No.: 11/582,824

(22) Filed: Oct. 18, 2006

Related U.S. Application Data
(60) Provisional application No. 60/728,227, filed on Oct. 19, 2005.

(51) Int. Cl. A61C 5/04; A61C 7/00

(52) U.S. Cl. 433/155; 433/149

(57) ABSTRACT

An improved dental matrices and clamp system having a wedge, a band and a clamp that. The wedge has a head portion that is used to receive a force for insertion. The wedge has two sidewalls that taper to a point. The band is attached to the top surface of the wedge. The band of the present invention is preferably malleable at the ends, with a generally oblong shape. The band can also have a length that is less than the length of the wedge. The clamp of the present invention has two arms that are biased by a resilient member. The arms are pivotally connected near the center. At the opposite end of the clamp there can a post that extends from clamp. In an alternative embodiment of the present invention the posts can have “V” shaped slits.

The application claims priority from provisional application 60/728,227 filed on Oct. 19, 2005.

### FIELD OF THE INVENTION

The present invention relates to improvements in dental matrices for use in tooth restoration. The invention also relates to clamps for use with dental matrices.

### BACKGROUND OF THE INVENTION

Many patients require tooth restorations in conjunction with a dental visit. For example, where caries is situated between teeth, the edge of the tooth may have to be drilled away to remove the decay. Similarly, there are times when an old filling needs to be removed and the tooth needs to be built up. A dental matrix is used in many of these instances. A dental matrix is usually a band or strip used to define the support form and separation for optimum tooth restoration. Dental Matrixes are commonly used for Class II restorations and other dental procedures. One of the issues in Class II situations is the difficulty of establishing a convex, positive proximal contour. To achieve this contour, the matrix of choice is ultra-thin, contoured and metallic. If physically possible, the matrix should be precontoured to create a natural tooth convexity in the finished restoration.

The matrix bands are positioned in the mouth. The bands can be small curved thin sheets of metal that are generally concave on one side and convex on the other. There are different types of these bands. Besides traditional bands, there can be pedodontic bands for primary molars. There are small bands for bicuspids and small molars. These bands have a smaller curvature. There are also large bands for deep cervical preparations.

After the band is positioned between the two teeth, a wedge is used. The wedge is driven completely through the interproximal space by a wand or other device. The wedges have a length with a bottom having a relatively flat surface. There are two generally flat side surfaces extending generally upwardly that meet at an apex that give the wedge a generally triangular cross section. The wedge has a first end and a second end. The first end is provided with a pointed tip so that the wedge can be inserted between the teeth. There is also a head on the second end to facilitate insertion into the inter-proximal space. The wedge tapers from the head end to the tip so that the tooth is separated from the adjacent tooth when the wedge is inserted. A College plier or other driving device is used to insert the wedge. After the wedge and band are inserted, a ring is placed with, for example, a forceps. The ring is a generally circular member having an open portion with a first end and a second end that are separated from each other. The ring has tines at each end of the ring that extend downwardly from the ring. The ring tines are placed adjacent to the bands wherever possible and force the band against the tooth. One type of prior art ring is the v-ring spring sold by Dentsply-caulk. This ring is a metal ring shaped member having a first and second tine. There is a v-shaped gap between the tines to accommodate a wedge. For m.o.d. restorations, bands are placed and wedged on both sides of the tooth.

To effectively use a matrix, there must be enough interproximal space to position the matrix without force or distortion. The ring, when placed prior to and left on during, cavity preparation, provides the necessary separation. To place the ring, it is grasped at its widest diameter with for example, a rubber dam forceps. The forceps are spread. The ring is placed with one tine in each interproximal space from buccal to lingual adjacent to the surface to be restored. The direction the ring points, mesial or distal, usually does not matter, though placing it so that the ring points mesially is usually more easily achieved due to easier access.

### OBJECTS OF THE INVENTION

It is an object of the present invention to produce an improved dental matrix system that is easy and cost effective to manufacture.

It is another object of the present invention to produce an improved dental matrix system that has the matrix attached to the wedge.

It is still another object of the present invention to produce an improved dental matrix system that has a wedge and a dental matrix band that is machined as one unit.

It is yet another object of the present invention to produce an improved dental matrix system that does not need a separate tool to set the dental clamp into position around the tooth.

It is still yet another object of the present invention to produce an improved dental matrix system that implements fewer parts than other conventional prior art dental matrix systems in which there is less likelihood of one of the parts of the system becoming dislodged, and being aspirated by the patient.

These and other objects of the present invention will become apparent to those skilled in the art from a review from the description provided below.

### SUMMARY OF THE INVENTION

The present invention is directed to improved tools for applying dental matrices, as well as an improved dental matrix that may be used with the tool. The tool is an improved clamp for use with the dental matrix and in particular a tool used in connection with inserting a dental matrix between two teeth.

The tool of the present invention has a first arm and a second arm that are joined together about a pivot point. Each arm has a first end and a second end. The first end is the hand hold end and the second end is the manipulation end. The two arms are joined together by a pivot member in a scissor type arrangement. Extending from the hand hold end of each arm is a spring. When the hand hold ends are pressed together, this spring provides a force to separate the hand hold ends. The first end of each arm has a gripping member or finger rest for the user to operate the device. The other end of the arm, i.e. the manipulation end, has a curved body portion ending in a downwardly extending tine. When the hand hold ends are pressed together, the tines separate. The spring holds the tine in place about a tooth when the device is positioned in a patient's mouth and holds them in place as the device is used. Thus, the second ends of the device can be adapted to hold any one or more of the following matrix bands up against the tooth:
Teledyne Tofflemire Matrix Bands,
Proxitac “Fell Through” Matrix Bands,
Contact Matrices of the type sold by Denville,
Tri Clip Section Matrix Bands,
   and others. The tines can be further modified if desired from rods or members extending generally at a 90° angle from the body of the arm to any desired configuration to fit the shape of the bands.

A second aspect of the present invention is an improved wedge. The wedge of the present invention has a body with a pointed safety tip at one end for ease of insertion between the teeth. The opposite end of the wedge has a head for receiving a force to insert the wedge. The body of the wedge has a base section that is relatively flat and two separate side walls extending upwardly that meet at an apex. Thus, the body of the wedge has a generally triangular cross section. The base of the body and each of the side walls are preferably also tapered as they extend towards the tip. Thus the wedge has a greater cross section in the region closer to the head piece than to the tip.

Extending upwardly from the apex of the wedge is a tab or band. The tab has a front and a rear surface that is generally parallel to the apex of the wedge portion. There is a top edge and a pair of side edges. The bottom portion of the tab is secured to the apex of the wedge portion. The tab preferably is a thin sheet of metal or plastic. In one embodiment the matrix portion of the article is a flat sheet extending upwardly from the apex of the wedge portion. In another embodiment, the tab has a section extending from the apex that is connected to a second portion that has one face concave and the other face convex. The side edges are preferably curved.

In use, the wedge is inserted into the inter-proximal space between the teeth by any suitable means. As the wedge is inserted between the teeth, the tab portion of the article also passes between the teeth.

The present invention improves on current prior art systems already known in the dentistry profession. The present system solves the standing problem of producing tight, anatomically accurate contacts on posterior composite restorations. The easy-to-use matrix system can be can be used in a large range of dental procedures, including, but not limited to Class II, M.O.D., pedodontic, sub-gingival and multiple tooth restorations. The present matrix system is indispensable in offering dentists the ability to restore the natural structure, function and beauty of a patients tooth.

The present invention includes a thin contoured matrix band that is attached to a wedge and a dental clamp. The dental clamp of the present invention provides a gentle teeth-separating force and holds the bands in place while the composite restoration is being performed.

The wedge, of the present invention, can be machined in a plethora of sizes, including, but not limited to, pedodontic; small bands for bicuspids and smaller molars; standard bands for most molar restorations; and large bands for deep cervical restorations.

The dental clamp of the present invention can be constructed from electro-polished stainless steel. The tines of the dental clamp can be machined so that they converge. In addition, the tines of the dental clamp can have burnished ends that grip the teeth at the gum line, thus ensuring clamp retention. The tines of the clamp can be machined to a number of lengths. Two lengths that have utility with the present invention are: a standard tine length that can be used for class II restoration and a slightly longer length that can allow placement over the standard size tine for performing M.O.D. and multiple tooth restorations.

The present invention improves over conventional prior art in the known dentistry market, because the wedge of the present invention follows the natural anatomy of the tooth, thus producing the following advantageous results. First, the present invention prevents or minimizes traumatizing of the gingival, which allows for the patient to have significantly less post operative discomfort. Second, the present invention will give the dentist a shorter and easier finishing time of the restoration by preventing or reducing the formation of the overhang of the material. Third, in a preferred embodiment the restorative material can be contained within the dental matrix. Fourth, the secured gripping block provides positive control with the dental clamp. A final improvement of the available prior art, is the improved safety tip, which prevents accidental digging into the papilla.

Furthermore, the present invention does not necessitate the need for a separate tool to position the dental clamp, as in dental matrix systems that implement the commonly used ring, which require a separate tool for separating the tines of the ring.

### BRIEF DESCRIPTION OF THE DRAWINGS

FIG. 1 is a end view of one embodiment of the wedge of the present invention.

FIG. 2 is a view of the opposite end of the wedge of FIG. 1.

FIG. 3 is a top view of the wedge of FIG. 1.

FIG. 4 is a side view of the wedge of FIG. 1.

FIG. 5 is a side view of and alternate embodiment of the wedge of FIG. 4.

FIG. 6 is a perspective view of the wedge of FIG. 5.

FIG. 7 is a perspective view of the wedge of FIG. 4.

FIG. 8 is a top view of the tool of the present invention.

FIG. 9 is a perspective view of the tool of FIG. 8.

FIG. 10 is an exploded view of the tool of FIG. 8.

FIG. 11 is a top view of an alternative embodiment of the present invention.

FIG. 12 is a perspective view of the tool of FIG. 11.

FIG. 13 is a perspective view of an alternative embodiment of the present invention.

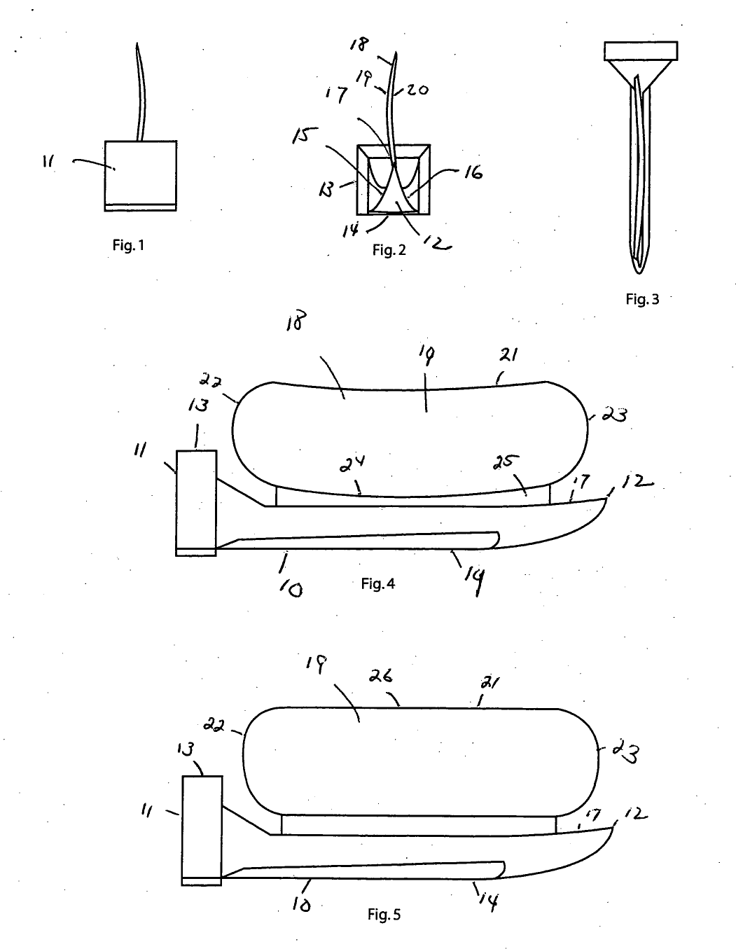

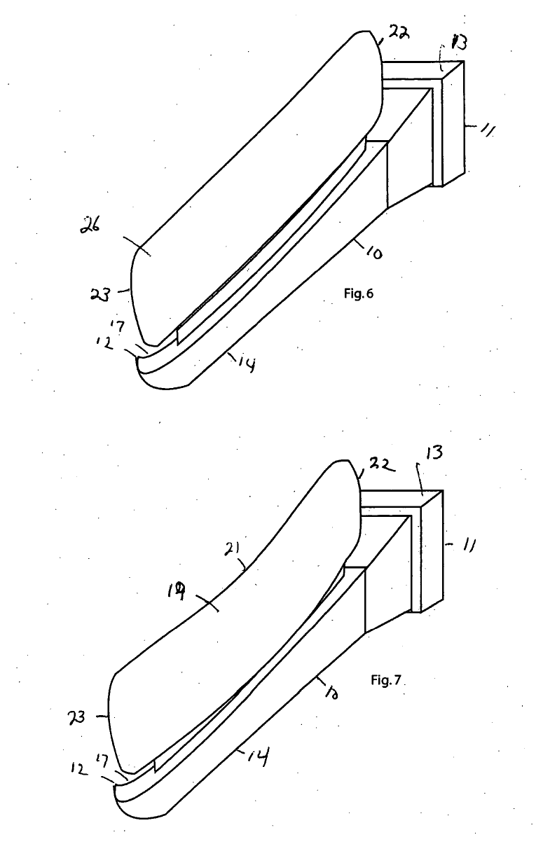

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

All cited references are incorporated herein by reference in their entireties. Citation of any reference is not an admission regarding any determination as to its availability as prior art to the claimed invention.

Turning now descriptively to the drawings, in which similar reference characters denote similar elements throughout the several views, the figures illustrate the present invention.

The following discussion describes in detail one embodiment of the invention and several variations of that embodiment. This discussion should not be construed, however, as limiting the invention to those particular embodiments. Practitioners skilled in the art will recognize numerous other embodiments as well. For a definition of the complete scope of the invention, the reader is directed to the appended claims.

The improved wedge of the present invention has a body 10 having a length that is about 14 to 16 mm and a first end 11 and a second end 12. One end 12 has a pointed safety tip for ease of insertion into the interproximal area of two teeth. The opposite end 11 of the wedge has a head 13 for receiving a force to insert the wedge. The head is typically of a larger cross-section than the body of the wedge. The body of the wedge has a base section 14 that is relatively flat and two separate side walls 15 and 16 extending upwardly that meet at an apex 17. Thus, the body of the wedge has a generally triangular cross section. The base of the body and each of the side walls are preferably also tapered as they extend towards the pointed tip. Thus the wedge has a greater cross section in the region closer to the head piece than to the tip.

Extending upwardly from the apex of the wedge is a tab or band 18. The tab or band may be made from the same material as the wedge or it may be a different material. The tab or band may be made from a thermoplastic material, a metal, a metallized thermoplastic material, an elastomeric or a multilayer composite of a thermoplastic material and a metal foil. The tab has a front 19 and a rear surface 20 that is generally parallel to the apex of the wedge portion. There is a top edge 21 and a pair of side edges 22 and 23. The bottom portion 24 of the tab is secured to the apex of the wedge portion or an extension 25 thereof. The tab preferably is a thin sheet of metal or plastic. The tab has a flat section or extension 25 extending from the apex of the wedge that is connected to a bottom portion that has one face concave and the other face convex. The side edges are preferably curved. In one embodiment (See FIGS. 5 and 6), the matrix portion of the article is a flat sheet 26 extending upwardly from the apex of the wedge portion

In use, the wedge is inserted into the inter-proximal space between the teeth by any suitable means. As the wedge is inserted between the teeth, the tab portion of the article also passes between the teeth. The improved wedge of the present invention may be translucent or transparent for light transmission. At least the middle area of the concave face of the second portion should be deadsoft, i.e. lack spring back, when pressure is placed on the convex face of the second portion. In addition, the middle area should be able to be burnished so that there may be tight contact with the tooth surface. Also, the ends of the tab should be flexible or malleable so that they wrap around the teeth.

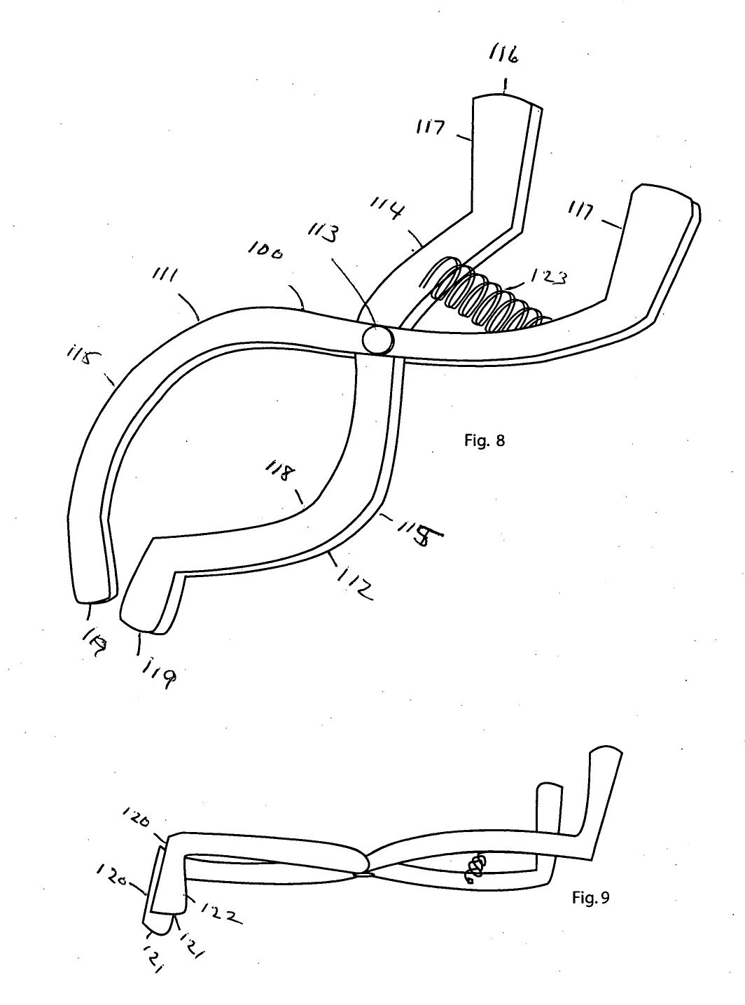

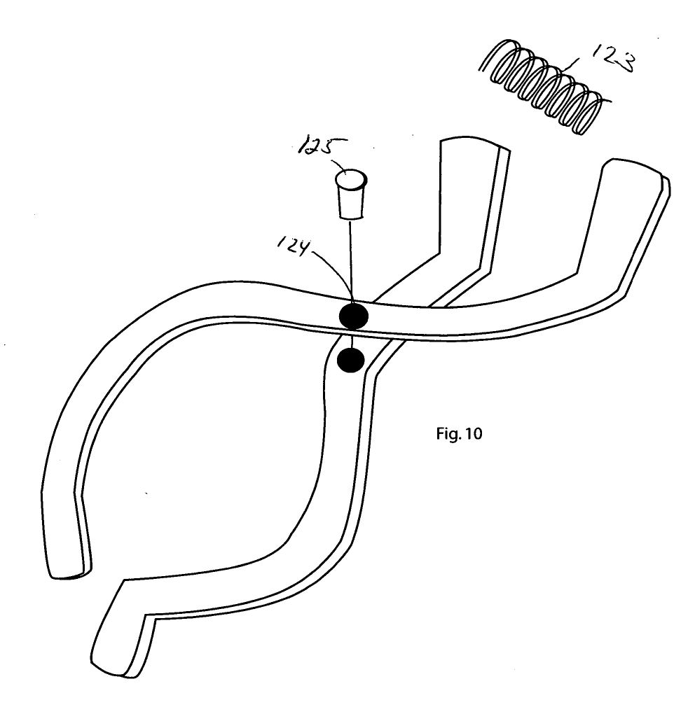

As seen in FIG. 8, there is a dental clamp 100. The dental clamp is used for spreading teeth to create tight contact. The clamp is also used to adapt the improved wedge of the present invention to the tooth structure. The clamp can be a unitary device or it may have two separate arms 111 and 112 that swivel about a pivot point 113. Each arm has a first portion 114 on one side of the pivot point and a second portion 115 on the opposite side of the pivot point. The first portion 114 extends from the pivot point and has an end 116 that provides a finger rest 117. The length of portion 114 will depend on the desired use of the clamp. For example, if the restoration procedure being performed is centrally located in the mouth, or in the rear end of the mouth, a longer portion 114 may be desired. Also, portion 114 can have a smooth outer surface, or portion 114 can have a textured surface. In the latter embodiment the textured surface will aid in squeezing end 116.

The pivot point is preferably an orifice 124 extending from a top surface of the arm to the bottom surface of the arm. A screw or a pin 125 with a head on each side can be used to secure the two arms together. It will be appreciated that and connection whereby the two arms pivot can be used. The finger rest 117 should be comfortable when the user is applying pressure on the clamp. The second portion of the arm is a finger 115 that has a preferably curved section 118. Each curved section of the arm provides an open area or embrasure for the tooth so that the device does not interfere with composite placement.

Each finger 115 ends in a tine 119. These tines 119 are preferably at about a 90° angle to the second portion. In a preferred embodiment tine 119 have four sidewalls 119a-119d and a flat base portion 199e. Sidewalls 119a-d connect to each other at their respective edges. Thus forming a generally diamond shape, when viewed from the bottom. This is a key feature of the present invention, because when a user positions clamp 100 over and adjacent to the teeth, clamp 100 will fit a snugly between the teeth. The tines 119 are generally triangular in shape and have a pair of sidewalls 120 and 121. Sidewall 120 extends at about 90° from the arm 115. Sidewall 121 extends generally about 90° from sidewall 120. A “hypotenuse” 122 having a slightly curved outer surface provides an angle that grabs the tooth and fits into the embrasure.

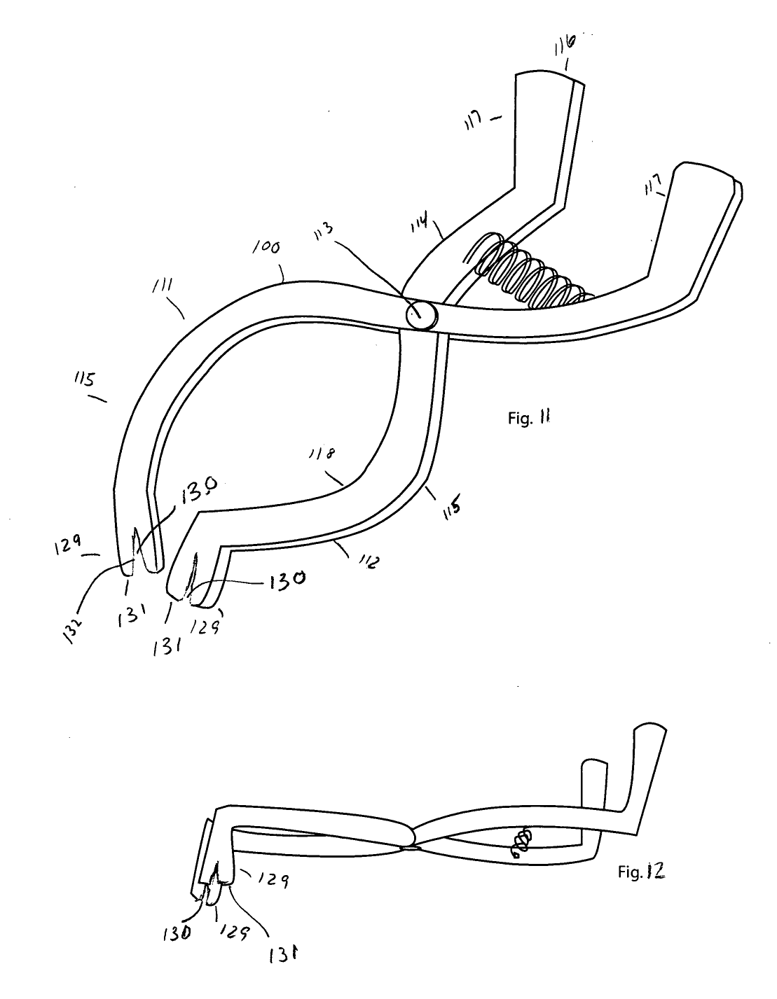

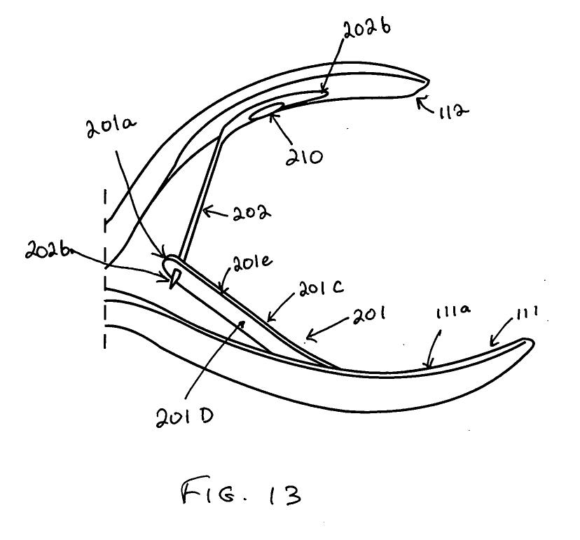

In an alternative embodiment, as seen in FIGS. 11 and 12, tines 129 can have a slit 130 near its center that extends toward distal end 131. This embodiment facilitates in positioning tines 129 of clamp 100 over band 18. That is, inside surface 132 of Slit 130 will be in contact with band 18.

In another alternative embodiment tines 119 may extend outwardly from base 119e and oppositely from each other. Conversely, in another embodiment tine 119 can extend inwardly toward each other.

In another embodiment rest 116 may extend in a generally upward direction from first portion 114. This embodiment will facilitate in separating tine 119.

The present invention also includes a biasing means. The biasing means can be any biasing means known in the available art. For example a spring, any suitable spring in the known art, including, but not limited to coil, helical, leaf, torsional and the like can be used. Another type of biasing means can be of the type implemented with tweezers. That is a thin metal band that extends from on arm to the other.

A spring 123 extends from one arm 111 to the other arm 112. The spring may be secured to the arm by any suitable means. When the finger rests are squeezed together, the spring contracts and simultaneously, the tines expand. When the tines are in position about a tooth, the pressure of the spring on the arms keeps the tines in position when pressure is removed from the finger rests.

In alternative embodiment spring 123 can be replace with a different biasing means, similar to those found in cuticle cutters. For Example, there can be two resilient members 201 and 202 attached to an inside surface of each of arms 111 and 112, as seen in FIG. 13.

One will now discuss resilient member 201. Resilient member 201 can be located anywhere on inside surface 111a of arm 111. In a preferred embodiment resilient member 201 was located near the rear end of arm 111. In addition, resilient member 201 can be attached by any suitable means known in the available art, including, but not limited to a rivet, bolt, screw, or the like. In a preferred embodiment resilient member 201 was attached via a rivet 210. Resilient member 201 can have any shape known in the art. In a preferred embodiment, resilient member 201 has a generally rectangular shape having two generally rounded ends, a first rounded end 201a and a second rounded end 201b. Also, resilient member 201 can have front and rear flat surfaces, 201c and 201d, respectively, meeting at top and bottom edges, 201e and 201f, respectively, as seen FIG. 13. Second rounded end 201b can be attached via rivet 210 near the rear end of arm 111. First rounded end 201a can contact a portion of 202 first rounded end 202a of arm 112.

Resilient member 202 can have the generally same shape, size, and attaching means as resilient member 201. One key distinction, between resilient member 201 and 202 is that first rounded end 202a of arm 112 can have a notched portion 202g.

In normal operation rounded end 201a of resilient member 201 will rest on notched portion 202g. This will keep rounded end 201a in position, thus preventing rounded end 201a from deflecting.

Resilient members 201 and 202 can be constructed from any suitable material known in the available art, including, but not limited to metal, plastic, nylon and the like. In a preferred embodiment resilient members 201 and 202 where constructed from metal.

While the clamp is shown as made from two separate arms, it will be appreciated that the clamp can also be a single member with a “memory.” When the clamp is made from a single member, the arms would be joined together in generally the area where the pivot point is on the above example. In this embodiment, there is no spring and the memory of the material used to make the clamp is relied on to provide the pressure on the tines.

The size of the clamp and the improved wedge can vary depending on the needs of the dentist and the patient. The wedge should extend past the matrix push into the interproximal area and open embrasure area.

As various changes could be made in the above constructions without departing from the scope of the invention, it is intended that all matter contained in the above description shall be interpreted as illustrative and not in a limiting sense. In the view above it will be seen that several objects of the invention are achieved and other advantageous results attained, as defined by the scope of the following claims.

1. A dental apparatus that facilitates a restoration procedure for teeth said clamp having a first arm and second arm that pivot about a pivot point, each of said arms having a first end and a second end, each of said arms having a post at one end of said arms, said first and second arms having a finger rests at the end of said arms opposite said post, said pivot point allowing said arms to swivel from a first position to a second position, each of said arms having a generally semi-circular section between said posts and said pivot point, said posts having at least one contact surface that adapted to contact the area between two teeth in a patient's mouth and said first and second arms having a spring means located between said arms.

2. The dental apparatus according to claim 1 wherein said finger rests extends in an upward direction at a generally 90 degree angle from said arm.

3. The dental apparatus according to claim 2 wherein said pivot point is located near the center of said clamp.

4. The dental apparatus according to claim 3 wherein said posts extend in a direction opposite the direction of said finger rests.

5. The dental apparatus according to claim 4 wherein said pivot point has an aperture that extends from a top surface of said first arm to a bottom surface of said second arm wherein a pin is used to secure said first arm to said second arm.

6. The dental apparatus according to claim 5 wherein said spring is rigidly attached to said arms.

7. The dental apparatus according to claim 5 wherein said spring is removably attached to said arms.

8. The dental apparatus according to claim 5 wherein said posts are generally triangular in cross-section and each having a pair of sidewalls with a “hypotenuse” said “hypotenuse” having a slightly curved outer surface.

9. The dental apparatus according to claim 5 wherein said posts are generally triangular in shape with a generally “V” shaped slit near their center that extends toward a distal end and each having a pair of sidewalls with a “hypotenuse” said “hypotenuse” having a slightly curved outer surface.

10. The dental apparatus according to claim 5 wherein each of said posts have a bottom base portion that project away from each other.

11. The dental apparatus according to claim 5 wherein said posts have a bottom base portion that project toward each other.

12. The dental apparatus according to claim 5 wherein said first portion of said clamp has a textured portion.

13. The dental apparatus according to claim 12 wherein said first portion of said clamp has a finger rest that extends perpendicularly from a top surface of said first portion, in a generally upward direction.

14. The dental apparatus according to claim 1 wherein said spring further comprises a first resilient member and a second resilient member.

15. The dental apparatus according to claim 1 wherein said first and second, resilient members, each having a first sidewall and a second sidewall, said first sidewall and second sidewalls, of first and second resilient members, forming a top edge, a bottom edge, and a first and second end.

16. The dental apparatus according to claim 15 wherein said first end of said first resilient member has an aperture located therethrough.

17. The dental apparatus according to claim 16 wherein said first end of said second resilient member forms a tip.

18. The dental apparatus according to claim 17 wherein said first end of said first resilient member contacts a portion of said tip.

19. The dental apparatus according to claim 18 wherein said first and second, resilient members, are attached to said clamp via a rivet.

20. The dental apparatus according to claim 18 wherein said first and second, resilient members, are attached to said clamp via screws.

21. A dental apparatus that facilitates a restoration procedure for teeth comprising:
a wedge, said wedge having a first end and a second end, said first end having a larger cross section than said second end, said wedge being defined by a first sidewall and a second sidewall said first and second sidewalls coming to a point at said second end, said sidewalls forming an edge said edge defining a top surface of said wedge; and
a band, said band extending from said top surface formed by said first and second sidewalls of said wedge, said band having a length, said band having a first sidewall and a second sidewall, said first and second sidewalls, of said band, forming a top edge and a bottom edge, said band being rigidly attached to said top surface of said wedge.

22. The dental apparatus according to claim 21 wherein said length of said band is less than the length of said wedge.

23. The dental apparatus according to claim 21 wherein said first end of said wedge has a generally square shape forming a head.

24. The dental apparatus according to claim 23 wherein said first and second sidewall of said wedge having a generally triangular cross-section.

25. The dental apparatus according to claim 24 wherein said band is removably attached to said top surface of said wedge.

26. The dental apparatus according to claim 24 wherein said wedge has a generally oblong shape being defined by a generally concave top surface and a generally convex bottom surface.

27. The dental apparatus according to claim 24 wherein said wedge has a generally oblong shape being defined by a generally straight top surface and a generally straight bottom surface.

28. The dental apparatus according to claim 24 wherein said band is a thermoplastic material.

29. The dental apparatus according to claim 24 wherein said wedge is an elastomeric material.

30. The dental apparatus according to claim 24 wherein said band is a metal.

31. The dental apparatus according to claim 24 wherein said first and second sidewalls, of said band, are flexible.

32. The dental apparatus according to claim 24 wherein said head of said wedge is sized to be able to receive a force for insertion.

33. The dental apparatus according to claim 32 wherein said wedge is translucent.
